(19) United States
(12) Patent Application Publication
(10) Pub. No.: US 2013/0181068 A1
(43) Pub. Date: Jul. 18, 2013

(54) INJECTION DEVICE HAVING IMPROVED SPRAY PREPARATION

(71) Applicants: Guenter Dantes, Eberdingen (DE); Bernd Krauss, Moensheim (DE); Andreas Krause, Unterriexingen (DE); Anja Melsheimer, Stuttgart (DE); Harald Lang, Bietigheim-Bissingen (DE); Martin Stahl, Remseck (DE)

(72) Inventors: Guenter Dantes, Eberdingen (DE); Bernd Krauss, Moensheim (DE); Andreas Krause, Unterriexingen (DE); Anja Melsheimer, Stuttgart (DE); Harald Lang, Bietigheim-Bissingen (DE); Martin Stahl, Remseck (DE)

(21) Appl. No.: 13/811,512

(22) PCT Filed: May 27, 2011
(86) PCT No.: PCT/EP2011/058770

§ 371 Date: Mar. 29, 2013

(30) Foreign Application Priority Data
Jul. 22, 2010 (DE) 10 2010 031 653.9

(51) Int. Cl. F02M 61/18

(52) U.S. Cl. CPC F02M 61/1833
USPC 239/557; 239/548

(57) ABSTRACT

An injection device having at least one first spray hole and one second spray hole, which form a spray hole pair, the first and the second spray holes being situated so that a distance between the two spray holes is less than, or equal to twice a maximum opening edge distance at an inflow side of the two spray holes, and the spray hole axes of the first and the second spray holes being situated in directions that are different from each other.

### FIELD OF THE INVENTION

The present invention relates to an injection device for injecting fluid, particularly fuel, having an improved spray preparation.

### BACKGROUND INFORMATION

Ignition devices for fuel are believed to be understood from the related art in various embodiments. Injectors are frequently used in this process in which an apertured spray disk is situated at the injection end. The spray holes provided in the apertured spray disk specify, among other things, the spray preparation during the injection of fuel. Such apertured spray disks have basically proven themselves, but there is a continuing effort further to lower the fuel consumption by an improved spray preparation and further to reduce the emission of pollutants.

### SUMMARY OF THE INVENTION

By contrast, the injection device according to the present invention, for injecting fluid, particularly fuel, having the features described herein, has the advantage that an improved spray preparation is possible, whereby the fuel consumption and the emission of pollutants are able to be further reduced. According to the present invention, an injection is performed, in this instance, in such a way that the injected fluid is broken up as broadly as possible upon its exit from the spray holes, and particularly forms a partially hollow lamella, so as to achieve a very good spray distribution. According to the present invention, this is achieved in that at least one first and one second spray hole are situated at a distance from each other which is less than, or equal to twice the opening edge distance at the intake side of the spray holes. In this context, the opening edge distance is that which shows the maximum distance between two edge points of the intake opening, when a straight line is drawn.

Furthermore, according to the present invention, spray hole axes of the spray holes are situated in different directions with respect to each other. Because of this, a spray preparation in different directions is achieved upon exit of the fuel from the first and the second spray hole, so that a relatively broad space range is covered by injected fluid. Because of the relatively close situation of the first and the second spray hole to each other, according to the present invention, in addition, particularly the intake at the two spray holes is influenced positively, in that the main intakes into the two spray holes influence each other and cause a strong deflection at the intake side of the spray holes. Consequently, in accordance with the present invention, the spray holes are deliberately not positioned at the same distances along the circumference, but may be pair-wise at a small distance, so that a positive mutual influence of the incident flow of the two spray holes of the spray hole pair is achieved. It should be noted that the condition also has to be satisfied in the case of two differently sized first and second spray holes, i.e. the distance is defined by the greatest opening edge distance of one of the spray holes.

The further descriptions herein show further developments of the present invention.

In particular, the distance between the first and the second spray hole amounts to 0.5 times to 1.5 times the maximum opening edge distance of the spray holes and, particularly, the distance between the two spray holes may correspond approximately to the maximum opening edge distance of the spray holes.

According to one further embodiment of the present invention, the spray hole axes of the first and second spray holes are situated at different angles of inclination. According to the present invention, by angle of inclination one should understand an angle at which the spray hole axis runs through a plane that includes the intake opening. The angles of inclination of the spray hole axes may be in a range of 5° to 85°, which may be 20° to 60°, and the angles of inclination particularly may be approximately up to 40°, and which may be approximately 40°.

Alternatively, the spray holes of a spray hole pair each has a spray hole axis that has the same angle of inclination but is aligned in a different direction. In this case, essentially for each spray hole, spray cones formed in the same manner may be achieved.

In a particular manner, an even number of spray holes is provided, in each case two of the spray holes may be situated pair-wise, corresponding to the situation of the first and the second spray hole. This allows a particularly good spray preparation, particularly a spray image having two spray jets respectively in cone shape being able to be generated; each spray jet being produced by a plurality of spray holes. Alternatively, an uneven number of spray holes is provided, which may produce a spray image having only one single spray jet in the shape of a cone.

At least one of the spray holes may have a shape that widens, particularly a shape that widens conically. The spray hole shape becomes wider, particularly, in the flow-through direction. Consequently, it is possible that one of the spray holes of a spray hole pair has a shape that widens, whereby an additional widening of the spray is achieved and, in particular, the individual spray jets form a partially hollow lamellae shortly after exiting, and the individual partially hollow lamellas unite to form a spray jet in the shape of a cone. In a particular manner, the two spray holes may have a widening shape, the shapes that are undergoing widening being able to be the same or different.

Particularly, an intake opening of a spray hole may be circular or oval. In circular intake openings, the maximum opening edge distance on the intake side corresponds to a diameter of the spray hole opening. In the case of an oval-shaped intake opening, the maximum opening edge distance corresponds to a largest axis of one of the oval-shaped openings, particularly a main axis of an ellipse.

The first and the second spray holes may be situated on a circular circumference, and the spray hole axes are situated at a hole distance angle of 20° to 60°, which may be 20° to 30° and in a particular manner about 25°.

According to one additional embodiment of the present invention, the injection device also includes a funnel-shaped intake space, which is situated at the intake side of the spray holes. Through this funnel-shaped intake space, a relatively sharp deflection of the intake fluid into the spray holes is achieved, which results in an augmented turbulence of the fluid and contributes to an improved spray preparation. A main flow of the fluid to each spray hole may be supplied at an intake angle, so that the sum of the intake angle and the angle of the spray hole axis is less than, or equal to 90°. The intake angle may be between 40° and 60°.

The injection device also may include a third and a fourth spray hole, which are situated at a distance from one another which is less than, or equal to twice the maximum opening edge distance on the intake side of the spray holes, and whose spray hole axes are situated at different directions with respect to one another. Furthermore, the third and fourth spray holes are situated opposite to the first and second spray hole.

In a further manner, the injection device includes a fifth and a sixth spray hole, which are situated opposite to each other and whose spray hole axes are situated in different directions. In this instance, the fifth and the sixth spray hole are situated at a greater distance from adjacent spray holes than spray holes situated pair-wise.

In order to enable as simple as possible and as cost-effective as possible a manufacturability, the spray holes may be situated in an apertured spray disk. The apertured spray disk is then able to be fastened simply to the injection device.

Exemplary embodiments of the present invention will be described in detail below, with reference to the accompanying drawings.

### BRIEF DESCRIPTION OF THE DRAWINGS

FIG. 1 shows a top view of a spray hole geometry of a fuel injector according to a first exemplary embodiment of the present invention.

FIG. 2 shows a sectional view along line II-II of FIG. 1.

FIG. 3 shows a schematic sectional view along line III-III.

FIGS. 4 through 10 show top views of spray hole geometries according to additional exemplary embodiments of the present invention.

### DETAILED DESCRIPTION

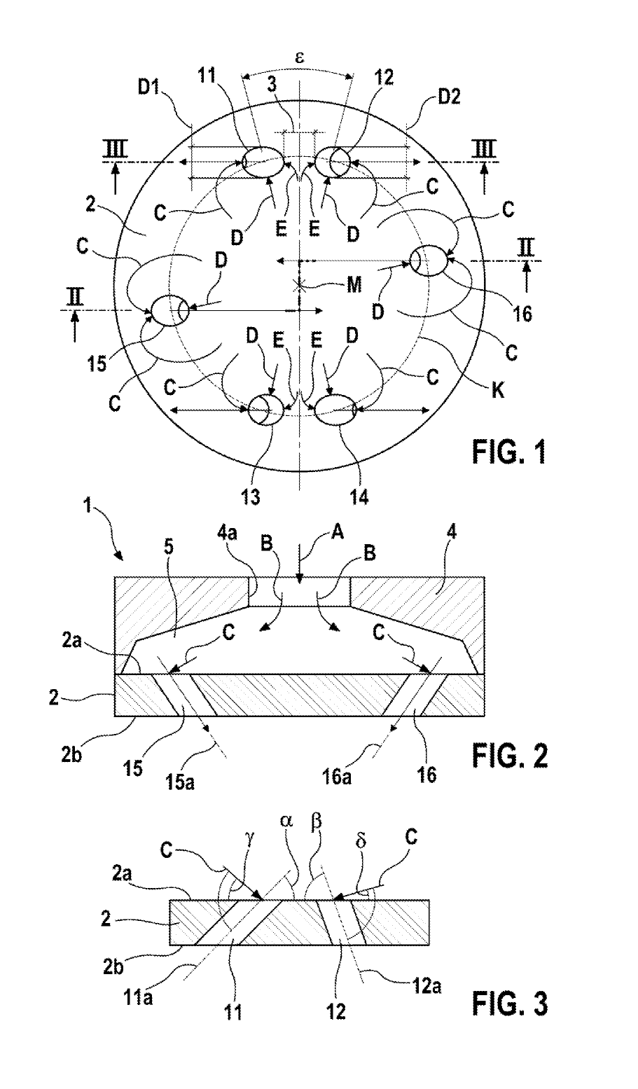

With reference to FIGS. 1 through 3, we shall describe below in detail a fuel injector having a spray-hole disk 2 according to a first exemplary embodiment of the present invention.

As may be seen in the sectional view of FIGS. 2 and 3, injector 1 includes a spray-hole disk 2, which is situated on a valve seat 4. Fuel is supplied for an injection through an opening 4a in valve seat 4 into a funnel-shaped, widening inflow space 5, and there it is supplied to the spray holes. In FIG. 2, the flow of the fuel to the spray holes is indicated by arrows A, B, C.

As may be seen in FIG. 1, spray-hole disk 2 includes six spray holes in total, namely, a first spray hole 11, a second spray hole 12, a third spray hole 13, a fourth spray hole 14, a fifth spray hole 15 and a sixth spray hole 16. In this context, first and second spray holes 11, 12 as well as third and fourth spray hole 13, 14 are situated in each case, as a spray hole pair, relatively close to each other. Spray holes 11, 12, 13, 14, 15, 16 are cylindrical and they all have the same diameter. For reasons of clarity, in FIG. 1 only the first diameter D1 of the first spray hole and diameter D2 of the second spray hole are drawn in, the cylindrical spray holes of each top view of FIG. 1 appearing oval-shaped. A distance 3 between first spray hole 11 and second spray hole 12 corresponds to diameter D1 and D2 of the two spray holes, in this instance. Consequently, first spray hole 11 and second spray hole 12 are situated relatively close to each other, whereby the flow at inflow side 2a of spray-hole disk 2 has a mutual effect. Alternatively, the spray holes may widen conically in the flow direction or even become reduced or even have different diameters, any combinations being possible.

FIG. 3 shows a sectional view through first and second spray hole 11 and 12. Reference numeral 11a designates a spray hole axis of first spray hole 11 and reference numeral 12a designates a second spray hole axis of second spray hole 12, in this instance. First spray hole 11 and second spray hole 12 are situated in different directions and also have different angles of inclination. The angle of inclination of the spray holes is in each case the angle which, at inflow side 2a, forms the smallest angle with a plane that includes the spray hole opening. In FIG. 3, the angle of inclination of the first spray hole is designated by α, and the angle of inclination of second spray hole 12 by β, where α amounts to about 45° and β about 70°.

Moreover, in FIGS. 1 and 3, arrows C show the inflow of fuel to spray holes 11, 12. Arrows C indicate the main flow direction of the fuel, in this context. In this instance, fuel is supplied to first spray hole 11 at an inflow angle of γ and to second spray hole 12 at an inflow angle of δ. The sum of angle of inclination α and inflow angle γ at first spray hole 11 is ca. 85°, and is thus less than 90°, in this context. The sum of inflow angle δ and of angle of inclination β at second spray hole 12 is ca. 85°. Because the sum of the angle of inclination and the inflow angle is less than 90° at each spray hole, a relatively flat incident flow may be achieved at the spray holes. Furthermore, as may be seen in FIG. 1, because of the close positioning of first and second spray hole 11, 12, a reinforced one-sided hole incident flow is achieved for each spray hole. In FIG. 1, the incident flows of the individual spray holes are indicated by the arrows, the length of the arrows corresponding to the force of the incident flows. In this instance, the main incident flow to the spray holes is designated in each case by the letter C. Smaller inflowing fuel quantities are characterized by arrows D and E.

As may further be seen in FIG. 1, a hole-to-hole angular distance ε between first spray hole 11 and second spray hole 12 is approximately 25°. The hole-to-hole angular distance is defined by an origin center point M of spray-hole disk 2. All spray holes 11, 12, 13, 14, 15 and 16 lie on a common circular circumference K, in this context. Alternatively, the spray holes may also not lie on a common circumference.

The pair-wise positioning of spray holes having a relatively low distance apart thus makes possible a reinforced one-sided incoming flow to the spray hole. This incoming flow, in this context, occurs with respect to a direction of inclination of the spray hole, so that as small as possible an angle between the main incident flow of the spray hole and the spray hole axis is implemented. This makes possible a very good fuel preparation.

Furthermore, it should be noted that the spray hole axes of the spray holes are situated in such a way that the spray jets generated do not meet in the injection space. This assures as broad as possible a spreading of the fuel droplets in the injection space without intersections. The thickness of the spray hole disk approximately corresponds to a diameter of the spray holes, in this context.

As may further be seen in FIG. 1, the main incident flow of fifth and sixth spray hole 15, 16 is mainly from the outside, based on the inclination of spray hole axes 15a and 16a towards the inside as well as the shape of inflow space 5. By contrast to this, the main incident flow in pair-wise situated spray holes 11, 12 as well as 13, 14 is essentially in a middle range, from the outside of the spray hole pair. A relatively slight incident flow is present at the inner regions of the spray holes. Furthermore, the angle of the spray hole axis is different from the angle of the main incident flow, which leads to an additional impact in the spray hole. Because of this, the jet generated by the spray hole is deformed more strongly to form a hollow cone, which further improves the fuel preparation. Spray hole angle α at the first spray hole amounts to ca. 45°, for example, and angle of main incident flow γ amounts to ca. 35°. The difference between the angle of main incident flow γ and angle of inclination α may be equal to, or greater than 10°.

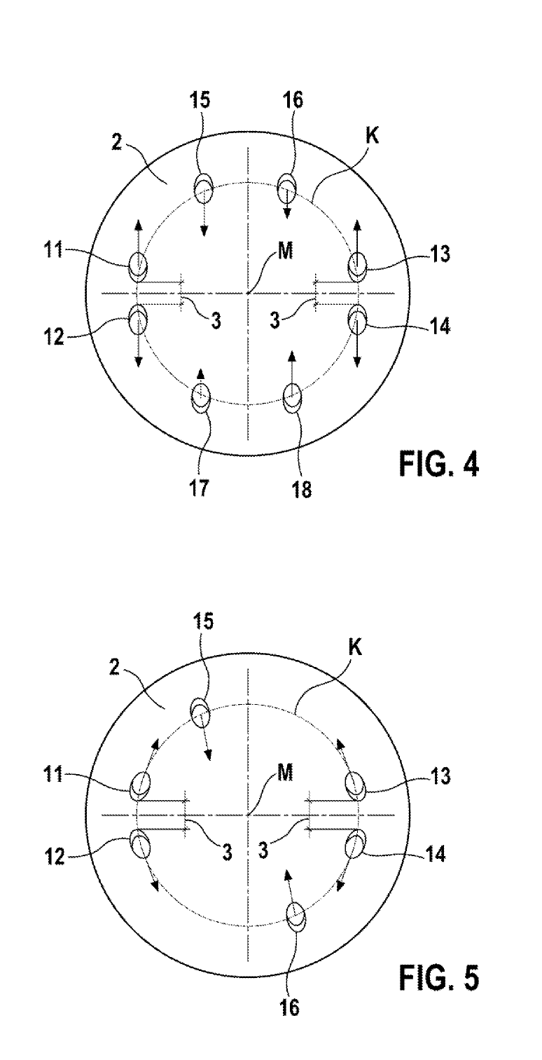

In the following, making reference to FIGS. 4 through 10, additional exemplary embodiments are described in detail, identical or functionally equivalent components being provided with the same reference numerals as in the first exemplary embodiment. The arrows drawn in in FIGS. 4 through 10 at the spray holes each indicate the direction of inclination of the spray holes, FIGS. 4 through 10 each representing a top view onto inflow sides 2a of spray hole disks 2.

In the second exemplary embodiment shown in FIG. 4, altogether eight spray holes (11 through 18 are provided, two pairs of spray holes 11, 12 and 13, 14 being situated at a distance 3 apart, which corresponds to a maximum opening edge distance of the spray holes on the inflow side. As may be seen in FIG. 4, the injection holes in this exemplary embodiment are developed to be cylindrical and, based on their inclination, the cylindrical spray holes form an oval at the surface of the spray hole disk, so that distance 3 corresponds to a longitudinal axis of the oval.

The centers of spray holes 11 through 18 all lie on a common circular circumference K. Furthermore, the spray directions of the spray holes are selected so that only two directions are present. In the case of pair-wise situated spray holes 11 and 12 as well as 13 and 14, in this context, the spray directions are selected so that they are opposite to one another (cf. FIG. 4).

In the third exemplary embodiment of FIG. 5, altogether six spray holes 11 through 16 are provided, the spray holes also being developed to be cylindrical. The centers of the spray holes lie on a common circular circumference K. In this context, the spray holes are inclined to one another in different directions, so that on the exit side, fuel exits in the most varied directions, as indicated by the arrows.

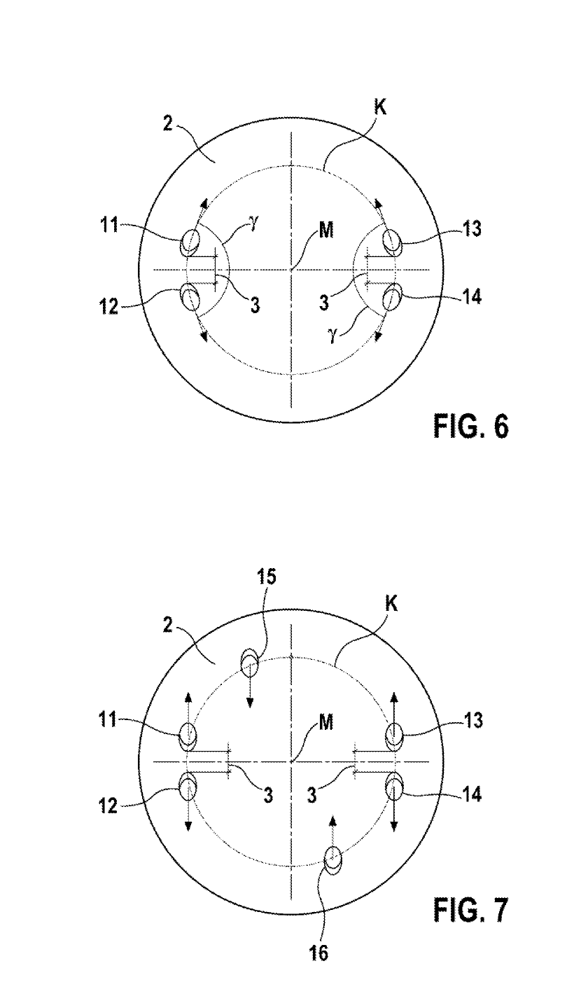

In the exemplary embodiment shown in FIG. 6, only four spray holes 11 through 14 are situated. The spray holes again lie on a circular circumference K and the opening directions of the spray holes are selected so that the spray hole axes of the pair-wise spray holes are directed opposite to one another by an angle γ of approximately 140°. Consequently, in this exemplary embodiment, all the present spray holes are positioned pair-wise, which leads to a particularly good fuel preparation.

The fifth exemplary embodiment shown in FIG. 7 essentially corresponds to the third exemplary embodiment of FIG. 5, but in contrast to that, the spraying directions of the spray holes are each directed in only two directions. These directions run counter to each other by 180°, and of the six spray holes situated, four are arranged into two spray hole pairs, and spray holes 11, 12 and 13, 14 are directed in opposite directions respectively.

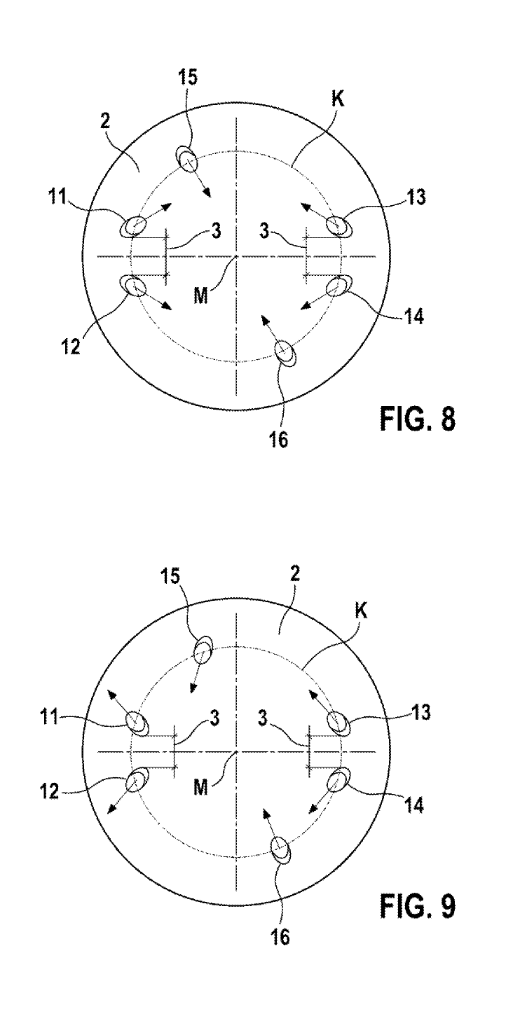

The sixth exemplary embodiment shown in FIG. 8 also has altogether six spray holes 11 through 16, spray holes 11 and 12 as well as 13 and 14 being each situated at a distance 3 with respect to one another. In this exemplary embodiment, distance 3 is equal to twice the maximum opening edge distance of spray holes 11, 12, 13, 14. Since the cylindrical spray holes in this exemplary embodiment are inclined in the axial direction again, the maximum opening edge distance is the main axis of the oval of the spray holes. The injection direction of all the spray holes 11 through 16 is directed inwards, in this context, so that a high fuel concentration is obtained in the middle region of an injection space.

The seventh exemplary embodiment shown in FIG. 9 essentially corresponds to the exemplary embodiment shown in FIG. 8, the injection directions of spray holes 11 through 16 being different. The injection direction of spray holes 11 and 12 is directed outwards.

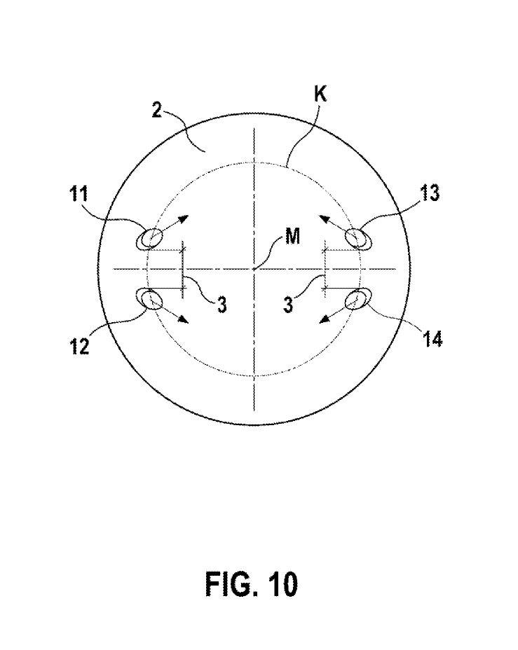

FIG. 10 shows an eighth exemplary embodiment of the present invention, which essentially corresponds to that shown in FIG. 5. By contrast to that, a distance 3 between first and second spray hole 11, 12 and third and fourth spray hole 13, 14 is equal to twice the opening edge distance of spray holes 11, 12 and 13, 14. Furthermore, the two spray hole pairs are situated opposite to each other and the injection directions of the respective injection holes also essentially point inwards.

It should be noted on all the specific embodiments described that at least two spray holes form one spray hole pair, which are situated at a maximum distance 3 from each other of twice the opening edge distance. Because of this, a positive mutual effect of the flow behavior at inflow side 2a is achieved, whereby an improved spray preparation comes about. The shape (circle, ellipse, etc.), the direction of the spray hole axis, the angle of inclination of the spray hole axis, the internal shape (cylindrical, conic, tapering, etc.) of the spray holes may be selected to be different in this context, the condition applying for the spray holes of the spray hole pair that distance 3 between the two spray holes be less than twice the maximum opening edge distance at the inflow side and the spray hole axes of the spray holes be situated in different directions from each other, in order to avoid that the generated fuel sprays intersect with one another.

1-13. (canceled)

14. An injection device for injecting a fluid, particularly fuel, comprising:
an injection arrangement having at least one first spray hole and one second spray hole, which form a spray hole pair;
wherein the first and the second spray holes are situated so that a distance between the two spray holes is less than or equal to twice the maximum opening edge distance at an inflow side of the two spray holes, and
wherein the spray hole axes of the first and the second spray holes are situated in directions that are different from each other.

15. The injection device of claim 14, wherein the distance between the first spray hole and the second spray hole is in a range of 0.5 to 1.5 times the maximum opening edge distance of the first and/or the second spray hole.

16. The injection device of claim 14, wherein spray hole axes of the first and the second spray holes are situated at different angles of inclination.

17. The injection device of claim 14, wherein each spray hole has a spray hole axis, which have the same angle of inclination, but are directed in different directions.

18. The injection device of claim 14, wherein at least four spray holes are provided, in each case two spray holes forming a spray hole pair.

19. The injection device of claim 14, wherein at least one of the spray holes has a shape that widens conically.

20. The injection device of claim 14, wherein the spray holes have a circular shape at the inflow side, the maximum opening edge distance at the inflow side being a diameter of the spray hole; or the spray holes have an oval shape at the inflow side, which is an elliptical shape, the maximum opening edge distance at the inflow side being defined as the largest axis of the oval shape.

21. The injection device of claim 14, wherein the first and the second spray holes are situated on a circular circumference and the spray hole axes are situated at an angular hole distance of 20° to 60°.

22. The injection device of claim 14, wherein a funnel-shaped inflow space is situated at an inflow side of the spray holes.

23. The injection device of claim 14, wherein a main flow of the fluid is supplied to each spray hole at an inflow angle so that the sum of the inflow angle and an angle of inclination of the spray hole axes is less than or equal to 90°.

24. The injection device of claim 18, wherein a third spray hole and a fourth spray hole are situated so that a distance between the third and the fourth spray holes is less than or equal to twice the maximum opening edge distance at the inflow side of the third and the fourth spray holes and the spray hole axes of the third and the fourth spray holes being situated in different directions with respect to each other, the third and the fourth spray holes being situated opposite the first and the second spray holes.

25. The injection device of claim 24, wherein a fifth spray hole and a sixth spray hole are situated opposite to each other and whose spray hole axes are situated in different directions.

26. The injection device of claim 14, wherein the spray holes are situated in a spray hole disk.

27. The injection device of claim 14, wherein the distance between the first spray hole and the second spray hole is in a range of 0.5 to 1.5 times the maximum opening edge distance of the first and/or the second spray hole, and the distance is equal to the maximum opening edge distance of the first and/or the second spray hole.

28. The injection device of claim 14, wherein the first and the second spray holes are situated on a circular circumference and the spray hole axes are situated at an angular hole distance of approximately 25°.
